(19) United States
(12) Patent Application Publication
(10) Pub. No.: US 2003/0091891 A1
(43) Pub. Date: May 15, 2003

(54) Catalyst composition for cell, gas diffusion layer, and fuel cell comprising the same

(76) Inventors: Tomoaki Yoshida, Kanagawa (JP); Toshio Morita, Kanagawa (JP)

Correspondence Address: SUGHRUE MION, PLLC, 2100 PENNSYLVANIA AVENUE, N.W., WASHINGTON, DC, 20037, US

(21) Appl. No.: 10/049,188

(22) PCT Filed: Jan. 16, 2002
(86) PCT No.: PCT/JP02/00252

(30) Foreign Application Priority Data
Jan. 16, 2001 (JP) 2001-007655
Jul. 30, 2001 (JP) 2001-228825

(51) Int. Cl. H01M 4/96; H01M 4/94; H01M 8/10; B01J 21/18; B01J 23/42

(52) U.S. Cl. 429/44; 429/30; 429/42; 429/32; 252/503; 502/180; 502/185

(57) ABSTRACT

A catalyst composition for a cell comprising catalyst-bearing conductive powder particles and fibrous carbon. A membrane-electrode assembly for a fuel cell comprising an electrolyte membrane and an electrode including a catalyst layer and a gas diffusion layer, the electrode being provided on each surface of the electrolyte membrane, wherein at least a portion of the surface of the gas diffusion layer which is in contact with the catalyst layer includes a layer containing a hydrophobic resin and fibrous carbon.

### DESCRIPTION OF THE RELATED APPLICATIONS

This application under U.S. Code 35 Section 111, paragraph (a) claims, under U.S. Code 35 Section 119, paragraph (e)(1), the benefit of the filing dates of U.S. Provisional Application No. 60/267,412 filed on Feb. 9, 2001 and No. 60/308,855 filed on Aug. 1, 2001 under U.S. Code 35 Section 111, paragraph (b).

### TECHNICAL FIELD OF THE INVENTION

The present invention relates to a catalyst composition for a fuel cell, a gas diffusion layer and fuel cells comprising the same, and more particularly to a catalyst composition useful for forming a catalyst layer of an electrode used in a polymer electrolyte fuel cell; to a layer assembly comprising an electrolyte, a catalyst layer and a gas diffusion layer; and to a fuel cell including these.

### BACKGROUND ART

Fuel cells have become of interest as a clean power-generating device of high efficiency which can generate electric energy through direct conversion of chemical energy.

As claimed in the type of electrolyte employed, fuel cells are classified into various types including an alkali type, a phosphoric acid type, a fused carbonate type, and a polymer electrolyte type. Of these, a polymer electrolyte fuel cell is considered to be a promising power source for electric automobiles, since the fuel cell can be operated at lower temperatures, is handled easily, and has a high power density.

FIG. 1 shows a cross section of the structure of a typical polymer electrolyte fuel single cell. The single cell has a basic structure including an ion-exchange membrane 4 containing an appropriate amount of water, and an anode catalyst layer 3 and a cathode catalyst layer 5 serving as electrodes which sandwich the ion-exchange membrane. Each of the anode catalyst layer 3 and the cathode catalyst layer 5 is formed by applying onto a sheet a paste of conductive powder particles bearing a catalyst which accelerates oxidation-reduction reaction (usually, platinum powder or platinum alloy powder).

A conductive porous anode gas diffusion sheet 2 and a porous cathode gas diffusion sheet 6, which allow water and gas generated during reaction to pass therethrough, are provided on the anode catalyst layer 3 and the cathode catalyst layer 5, respectively. Separator plates 1 are provided on the diffusion gas sheets so as to form reaction gas passages, to thereby produce the single cell. A battery of high power is produced by laminating a plurality of the single cells.

In order to attain efficient reaction of a fuel cell, in a catalyst layer, three phases—a catalyst phase, a fuel gas or oxidizing gas phase, and an electrolyte phase—must be in contact with one another in a highly effective manner; i.e., the interfaces of the three phases are a critical factor. However, since the catalyst layer is usually formed from platinum-catalyst-bearing conductive carbon and an ion-exchange resin, when “wetting” of the layer occurs due to water generated through reaction, the surface of the platinum catalyst is covered with water, and contact between the catalyst and oxygen gas or hydrogen gas is prevented, resulting in lowering of catalyst activity as the area of a “wet portion” of the catalyst increases.

Japanese Patent Application Laid-Open (kokai) No. 7-211324 discloses an electrode containing fine particles of a highly hydrophobic fluorine-based bonding agent (e.g., polytetrafluoroethylene: hereinafter abbreviated as “PTFE”). Although incorporation of PTFE can prevent “wetting” of a catalyst layer, transfer of electrons in the catalyst layer is prevented, since PTFE has no electrical conductivity.

In the case of a conventional polymer electrolyte fuel cell, an ion-exchange membrane is sandwiched by two thin-membrane electrodes, and the ion-exchange membrane and the two thin-membrane electrodes are bonded together through hot pressing, to thereby produce a membrane-electrode assembly. However, through this method, a spherical catalyst carrier, an ion-exchange resin, and PTFE are tightly bonded together by means of hot pressing, thereby failing to provide sufficient gas passages.

The power of a polymer electrolyte fuel cell is greatly affected by the drying condition of a polymer membrane serving as an electrolyte. Therefore, in order to prevent “wetting” of a catalyst and drying of the polymer membrane, careful moisture control (humidification control) must be practiced inside or outside the fuel cell.

A first object of the present invention is to provide a catalyst composition for a fuel cell, which prevents “wetting” of a catalyst layer, which causes no change in electrical resistance or reduction of electrical resistance, which provides gas passages for enhancing gas permeability, which contributes to enhancement of power-generating characteristics of a fuel cell, and which realizes simple humidification control of the cell. Another object of the present invention is to provide a useful electrode material containing the catalyst composition. Yet another object of the present invention is to provide a fuel cell including the useful electrode material containing the catalyst composition.

Also, In order to attain efficient reaction of a fuel cell, water generated in the cathode must be removed. Therefore, the porous cathode gas diffusion sheet is an important element of the cell.

Japanese Patent Application Laid-Open (kokai) No. 2001-6699 discloses a gas diffusion layer in which a paste containing carbon powder and a fluorine-based resin is applied onto carbon paper or carbon cloth. The carbon powder is formed of single-species carbon and has a particle size of 0.01-0.1 μm. However, when the gas diffusion layer containing the single-species carbon particles is pressed in the course of formation of a cell, spaces of the layer required for gas diffusion are reduced.

Japanese Patent Application Laid-Open (kokai) No. 8-7897 discloses a gas diffusion layer formed through deposition of carbon fiber entangled with carbon particles. The gas diffusion layer does not require an electrode substrate such as carbon cloth or carbon paper. However, forming a membrane-electrode composite assembly without use of an electrode substrate is difficult. In addition, since carbon particles and a hydrophobic resin are applied onto the surface of a substrate formed from short carbon fiber, and a catalyst layer is formed on the resultant gas diffusion layer, the catalyst layer comes into contact with a layer of the carbon particles and the hydrophobic resin, resulting in reduction of spaces necessary for gas diffusion.

A second object of the present invention is to provide a membrane-electrode assembly for a fuel cell, which causes no change in contact resistance between a gas diffusion layer and a catalyst layer or reduction of the contact resistance, which provides gas passages for enhancing gas permeability in a high current density region, which contributes to enhancement of power-generating characteristics of a fuel cell, and which realizes simple humidification control; as well as a fuel cell.

### SUMMARY OF THE INVENTION

The present inventors have discovered that the above objects of the present invention can be accomplished by adding fibrous carbon to the catalyst layer and/or the interface between gas diffusion layer and the catalyst layer, i.e., by (1) a fuel cell comprising an electrolyte sandwiched by electrodes having a catalyst layer and a gas diffusion layer, or a layer assembly used therefor, characterized in that (i) the catalyst layer comprises a catalyst-bearing conductive powder particles and a fibrous carbon, and/or (ii) the gas diffusion layer comprises a layer containing a water repellant resin and a fibrous carbon at least part of the surface of the gas diffusion layer in contact with the catalyst layer.

More specifically, in accordance with the first aspect of the present invention, there is provided a cell which enables simple humidification control and exhibits enhanced power-generating efficiency, an electrode material used in the cell, and a catalyst composition. That is,

(2) a catalyst composition for a cell comprising catalyst-bearing conductive powder particles and fibrous carbon;

(3) a catalyst composition for a cell according to (2), wherein the catalyst accelerates oxidation-reduction reaction in a fuel cell;

(4) a catalyst composition for a cell according to (2) or (3), wherein the catalyst is platinum or a platinum alloy;

(5) a catalyst composition for a cell according to any one of (2) through (4), wherein the conductive powder particles are conductive carbon black or conductive carbonaceous powder particles;

(6) a catalyst composition for a cell according to any one of (2) through (5), wherein the conductive powder particles are at least one species selected from the group consisting of furnace black, acetylene black, thermal black, channel black, and Ketjen Black;

(7) a catalyst composition for a cell according to any one of (2) through (6), wherein the fibrous carbon is at least one species selected from the group consisting of PAN-based carbon fiber, pitch-based carbon fiber, and a carbon nano-tube;

(8) a catalyst composition for a cell according to any one of (2) through (16), wherein the fibrous carbon is vapor grown carbon fiber;

(9) a catalyst composition for a cell according to (7) or (8), wherein the entirety of the catalyst-bearing conductive powder particles and the fibrous carbon contains the fibrous carbon in an amount of 0.1-30 mass %;

(10) a catalyst composition for a cell according to (8) or (9), wherein the vapor grown carbon fiber has been heat-treated at a temperature of at least 2,300° C.;

(11) a catalyst composition for a cell according to any one of (8) through (10), wherein the vapor grown carbon fiber contains boron in an amount of 0.01-10 mass %;

(12) a catalyst composition for a cell according to any one of (7) through (11), wherein the fibrous carbon has a fiber filament diameter of 10-300 nm;

(13) a catalyst composition for a cell according to any one of (7) through (12), wherein the fibrous carbon has a fiber filament length of 100 μm or less;

(14) an electrode material comprising a conductive substrate and a catalyst layer formed thereon, the catalyst layer containing a catalyst composition for a cell as recited in any one of (2) through (13);

(15) an electrode material according to (14), wherein the conductive substrate is a porous conductive substrate; and

(16) a polymer electrolyte fuel cell comprising a polymer electrolyte membrane and a pair of electrodes which sandwich the electrolyte membrane, each electrode including a catalyst layer, characterized in that the catalyst layer includes a conductive substrate and a catalyst layer containing catalyst-bearing conductive powder particles and fibrous carbon.

In accordance with the second aspect of the present invention, there is provided a fuel cell which enables reduction of contact resistance and enhancement of gas permeability and gas diffusibility and exhibits enhanced power-generating efficiency; as well as an assembly used therefor. That is,

(17) a membrane-electrode assembly for a fuel cell comprising an electrolyte membrane and an electrode including a catalyst layer and a gas diffusion layer, the electrode being provided on each surface of the electrolyte membrane, wherein at least a portion of the surface of the gas diffusion layer which is in contact with the catalyst layer includes a layer containing a hydrophobic resin and fibrous carbon;

(18) a membrane-electrode assembly for a fuel cell according to (17), wherein at least a portion of the surface of the gas diffusion layer which is in contact with the catalyst layer further includes conductive powder particles;

(19) a membrane-electrode assembly for a fuel cell according to (17) or (18), wherein at least a portion of the surface of the gas diffusion layer which is in contact with the catalyst layer further includes spaces;

(20) a membrane-electrode assembly for a fuel cell according to (19), wherein, in a cross section of the gas diffusion layer, the cross section area of spaces having a size of 0.1-50 μm accounts for at least 40% of the total cross section area of all the spaces;

(21) a membrane-electrode assembly for a fuel cell according to any one of (18) through (20), wherein the conductive powder particles are conductive carbon black or conductive carbon powder particles;

(22) a membrane-electrode assembly for a fuel cell according to any one of (17) through (21), wherein the fibrous carbon of the layer comprising the hydrophobic resin and the fibrous carbon is vapor grown carbon fiber, and the layer contains the vapor grown carbon fiber in an amount of 1-95 mass %;

(23) a membrane-electrode assembly for a fuel cell according to (22), wherein the vapor grown carbon fiber has been formed through heat treatment at a temperature of at least 2,000° C.;

(24) a membrane-electrode assembly for a fuel cell according to (22) or (23), wherein the vapor grown carbon fiber contains boron in an amount of 0.01-10 mass %;

(25) a membrane-electrode assembly for a fuel cell according to any one of (22) through (24), wherein the vapor grown carbon fiber has a fiber filament diameter of 500 nm or less;

(26) a membrane-electrode assembly for a fuel cell according to any one of (22) through (25), wherein the vapor grown carbon fiber has a fiber filament length of 100 μm or less;

(27) a membrane-electrode assembly for a fuel cell according to any one of (17) through (26), wherein the hydrophobic resin is a fluorine-based resin;

(28) a process for producing a layer assembly for a fuel cell, comprising a step for forming a gas diffusion layer by applying a conductive porous substrate onto or immersing the conductive porous substrate in a composition comprising conductive powder particles, a hydrophobic resin, and fibrous carbon; a step for forming an electrode by forming a catalyst layer comprising catalyst-bearing carbon particles on the surface of the gas diffusion layer, the composition being applied onto the surface of the gas diffusion layer or the gas diffusion layer being immersed in the composition; and a step for bonding the catalyst layer of the electrode to each surface of an electrolyte membrane;

(29) a fuel cell comprising a membrane-electrode assembly as recited in any one of (17) through (27) and separators which sandwich the membrane-electrode assembly; and

(30) a fuel battery comprising at least two fuel cells as recited in (29), which are layered together.

### BRIEF DESCRIPTION OF THE DRAWINGS

FIG. 1 is a cross-sectional view schematically showing the basic structure of a typical polymer electrolyte fuel single cell.

FIG. 2 is a graph showing the relation between current density and voltage in Examples 1 and 2 and Comparative Example 1.

FIG. 3 is a graph showing the relation between current density and voltage in Examples 1 and 3 and Comparative Example 1.

FIG. 4 is a graph showing the relation between current density and voltage in Example 4.

FIG. 5 is a graph showing the relation between current density and voltage in Comparative Example 2.

FIG. 6 is a schematic representation showing a gas diffusion sheet.

FIG. 7 is a graph showing the relation between current density and voltage in Examples 5 and 6 and Comparative Example 3.

FIG. 8 is a graph showing the relation between current density and voltage in Examples 6 and 7 and Comparative Example 3.

FIG. 9 is a graph showing the relation between current density and voltage in Examples 5 and 8 and Comparative Example 3.

### DESCRIPTIONS OF THE PREFERRED EMBODIMENTS OF THE INVENTION

The present invention will next be described in detail.

(First Aspect)

The catalyst composition for a cell of the first aspect of the present invention contains catalyst-bearing conductive powder particles and fibrous carbon.

Examples of the catalyst used in the present invention include a variety of catalysts which accelerate oxidation-reduction reaction in a fuel cell, such as ruthenium, rhodium, palladium, osmium, iridium, platinum, and alloys thereof. The catalyst is not particularly limited to these examples. Typically, platinum or a platinum alloy is used.

No particular limitation is imposed on the type of the conductive powder particles serving as a carrier of the catalyst, so long as the particles have conductivity. However, conductive powder particles having a specific surface area sufficient for bearing the catalyst are preferred, and, for example, carbon black is preferably used. Microspherical carbon black having a primary particle size of 1 μm or less is particularly preferred. For example, when the catalyst is platinum, the amount of platinum carried on the carbon black is preferably 10-60 mass %.

In the first aspect of the present invention, commercially available carbon black having an average primary particle size of 1 μm or less can be used. Examples of carbon black include, from the viewpoint of production process, oil furnace black produced through incomplete combustion of aromatic hydrocarbon oil, acetylene black produced through complete combustion and thermal decomposition of acetylene, thermal black produced through complete combustion of natural gas, and channel black produced through incomplete combustion of natural gas. In the present invention, any of the aforementioned carbon blacks can be used.

In the first aspect of the present invention, particularly preferably, oil furnace black or acetylene black is used, for the reasons described below. An important factor in the determination of the ability of carbon black as a conductive material is chain structure (aggregation structure) of primary particles. Typically, carbon black assumes an aggregation in which microspherical primary particles aggregate and form irregular branched chains. When carbon black is in a “high structure state” in which a large number of primary particles are present and chains of the particles are branched to thereby form a complicated structure, the carbon black exerts excellent conductivity imparting effect. Since oil furnace black or acetylene black easily assumes such a high structure state, it is preferably used.

Examples of the fibrous carbon which can be used in the first aspect of the present invention include PAN-based fibrous carbon, pitch-based fibrous carbon, vapor grown fibrous carbon, and fibrous carbon having a fiber filament diameter on the scale of one nanometer, which is called a “nano-tube.” However, since pitch-based carbon fiber or PAN-based carbon fiber has a fiber filament length of more than 100 μm, uniform mixing of the carbon fiber with a catalyst is not easily attained. Therefore, in consideration of uniform mixing with a catalyst and conductivity, a nano-tube or vapor grown carbon fiber (hereinafter the fiber may be abbreviated as “VGCF”) is preferably used. Particularly, VGCF which has been heat-treated and exhibits enhanced electrical conductivity is preferred, since the VGCF has appropriate elasticity.

“VGCF” is produced through thermal decomposition of a gas, such as hydrocarbon gas, in a vapor phase in the presence of a metallic catalyst.

A variety of processes for producing VGCF are known, including a process in which an organic compound such as benzene or toluene, serving as a raw material, and an organic transition metal compound such as ferrocene or nickelocene, serving as a metallic catalyst, are introduced into a high-temperature reaction furnace together with a carrier gas, to thereby produce VGCF on a substrate (Japanese Patent Application Laid-Open (kokai) No. 60-27700); a process in which VGCF is produced in a dispersed state (Japanese Patent Application Laid-Open (kokai) No. 60-54998); and a process in which VGCF is grown on a reaction furnace wall (Japanese Patent No. 2778434). Japanese Patent Publication (kokoku) No. 3-64606 discloses a process in which metal-containing particles carried on a refractory support of, for example, alumina or carbon are brought into contact with a carbon-containing compound at high temperature, to thereby produce VGCF having an diameter of 70 nm or less.

In the first aspect of the present invention, any of the VGCFs produced through the aforementioned processes can be used.

In the first aspect of the present invention, VGCF having a fiber filament diameter of 300 nm or less and a fiber filament length of 200 μm or less can be used. Preferably, VGCF having a fiber filament diameter of 10-300 nm and a fiber filament length of 100 μm or less is used. This VGCF typically has a branched structure. In this case, the term “fiber filament length” refers to the length of a branched filament as measured from one branch point to an end or the length of a filament between two adjacent branch points.

The reason why VGCF having a fiber filament diameter of 10 nm or more is preferred will be described below. VGCF having a fiber filament diameter of less than 10 nm is impractical, due to difficulty in industrial mass production, and handling is troublesome because of its fine structure. In contrast, VGCF having a fiber filament diameter of more than 300 nm is not satisfactorily entangled with particles of a catalyst for a cell, from the viewpoint of the size and shape of the catalyst particles. Therefore, even when the VGCF is incorporated, the effect of the VGCF on conductivity is difficult to obtain.

When VGCF has a fiber filament length of more than 100 μm, thinning of a catalyst layer becomes difficult, since the VGCF encounters difficulty in attaining uniform mixing with a catalyst for a cell, and the VGCF fails to yield remarkable effect.

In the first aspect of the present invention, preferably, VGCF is heat-treated in a non-oxidizing atmosphere (e.g., argon, helium, or nitrogen gas) at a temperature of 2,300° C. or higher, preferably 2,500-3,500° C. More advantageously, heat treatment is carried out in the presence of a boron compound. When VGCF is heat-treated in the presence of a boron compound, the heat treatment temperature can be reduced by several hundred degrees as compared with the case where the boron compound is not used.

No particular limitation is imposed on the boron compound used during heat treatment of VGCF, so long as the boron compound generates boron through heating, and the boron content of VGCF becomes 0.01-10 mass %, preferably 0.1-5 mass % after heat treatment. Examples of the boron compound include boron carbide (B₄C), boron oxide (B₂O₃), boric acid, boric acid salts, boron nitride, and organic boron compounds. The boron compound may assume a solid, liquid, or gaseous form. In the present invention, an inorganic boron compound is preferred, since it is reliably available and enables easy operation. Particularly, boron carbide is preferred.

The amount of a boron compound which is incorporated into VGCF before heat treatment must be greater than the target boron content of VGCF, since boron may be evaporated depending on heat treatment conditions. No particular limitation is imposed on the amount of a boron compound to be incorporated, which depends on chemical properties and physical properties of the compound. When boron carbide is used, it is preferably incorporated into VGCF in an amount of 0.05-10 mass %, more preferably 0.1-5 mass %.

As used herein, the expression “VGCF contains boron” refers to the case in which a portion of incorporated boron forms a solid solution and is present in the surface portion of carbon fiber, between carbon-atom-layers, or in a hollow portion of carbon fiber; or the case in which a portion of carbon atoms is substituted by boron atoms.

When VGCF is heat-treated at 2,300° C. or higher, not only electrical conductivity but also characteristics such as chemical stability and thermal conductivity are improved. Therefore, when the thus-treated VGCF is used in combination with a catalyst for a fuel cell, power-generating efficiency (the amount of power generated on the basis of unit volume) of the resultant fuel cell is enhanced, and durability of the fuel cell (the ratio of the maximum power of the cell after continuous use for 1,000 hours or more to the initial maximum power of the cell) is also enhanced.

Particularly when VGCF is heat-treated at 2,500° C. or higher, the resultant VGCF of high crystallinity exerts remarkable effect of enhancing such fuel characteristics. Therefore, in the present invention, the degree of graphitization-crystallization of VGCF is enhanced by means of addition of boron. Mixing of a boron compound and VGCF may be carried out by means of any method without use of a special apparatus, so long as they are carefully mixed so as to form a uniform mixture.

VGCF may be heat-treated by use of any furnace; for example, an Acheson furnace, a high-frequency furnace, or a furnace employing a graphite heater, so long as VGCF can be treated at a desired temperature.

In the case of an Acheson furnace, a non-oxidizing atmosphere during heating is obtained by burying a substance to be heated into carbon powder. In the case of another furnace, a non-reducing atmosphere is obtained, if desired, by substituting an atmosphere with an inert gas such as helium or argon.

No particular limitation is imposed on the heat treatment time, and the heat treatment time may be appropriately determined such that the temperature of the entirety of a substance to be heated reaches a predetermined temperature.

The catalyst composition for a cell of the first aspect of the present invention is obtained by mixing catalyst-bearing conductive powder particles and fibrous carbon, which are primary components. In the first aspect of the present invention, preferably, the primary components of the catalyst composition contain the fibrous carbon in an amount of 0.1-30 mass %; i.e., the primary components contain the catalyst-bearing conductive powder particles in an amount of 99.9-70 mass % and the fibrous carbon in an amount of 0.1-30 mass %. In the first aspect of the present invention, the primary components more preferably contain the fibrous carbon in an amount of 1-25 mass %, much more preferably 2-20 mass %.

When the incorporation amount of the fibrous carbon is less than 0.1 mass %, the effect of the incorporated fibrous carbon is difficult to obtain, whereas when the incorporation amount exceeds 30 mass %, the content of a catalyst such as platinum is reduced, resulting in deterioration of cell characteristics.

The catalyst-bearing conductive powder particles and the fibrous carbon are uniformly mixed by use of a continuous mixing apparatus such as a screw feeder, or by use of a batch-type mixing apparatus such as a mixing roll.

In the first aspect of the present invention, the catalyst composition may contain an additive, a hydrophobic resin, etc., so long as such an additive does not impede the effects of the present invention.

A catalyst layer is formed from the catalyst composition in which the amount of the fibrous carbon is regulated so as to fall within the aforementioned range.

Specifically, a solution mixture prepared by incorporating a solvent into a solution in which the catalyst composition and an ion-exchange resin are dissolved is stirred sufficiently by use of, for example, a ball mill or a planetary stirring ball mill, to thereby prepare a paste-like solution mixture. The paste-like solution mixture is applied onto a conductive substrate such as a carbon sheet or a Teflon sheet, and then dried at a temperature such that the solvent is evaporated sufficiently, to thereby form a catalyst layer on the substrate; i.e., to thereby produce an electrode material. In the first aspect of the present invention, the conductive substrate is preferably a porous conductive substrate.

The aforementioned ion-exchange resin is preferably a perfluorocarbon resin or a similar resin having an ion-exchange group such as a sulfonyl group or a carboxyl group.

A single cell having, for example, a structure shown in FIG. 1 can be produced by sandwiching an ion-exchange membrane by the electrode materials of the first aspect of the present invention, and furthermore, a fuel cell can be produced. The ion-exchange membrane may be a known ion-exchange membrane.

As described above, in the first aspect of the present invention, spherical catalyst-bearing conductive powder particles are mixed with fibrous carbon. Through this mixing, spaces suitable for gas diffusion can be formed. Since the spaces are not completely lost by means of, for example, hot pressing, and the spaces can be maintained due to the presence of the fibrous carbon, gas passages can be provided sufficiently after formation of a fuel cell.

(Second Aspect)

The second aspect of the present invention will next be described in detail.

The second aspect of the present invention relates to a gas diffusion layer including a layer comprising a hydrophobic resin and fibrous carbon; and to a layer assembly for a fuel cell including the gas diffusion layer including conductive powder particles, the layer comprising the hydrophobic resin and the fibrous carbon.

No particular limitation is imposed on the type of the conductive powder particles, so long as the particles are of carbon material having conductivity. However, for example, carbon black is preferably used. Microspherical carbon black having a primary particle size of 1 μm or less is particularly preferred. The secondary particle size of the carbon black is preferably about 15 μm or less.

In the second aspect of the present invention, commercially available carbon black having an average primary particle size of 1 μm or less can be used. Examples of carbon black include, from the viewpoint of production process, oil furnace black produced through incomplete combustion of aromatic hydrocarbon oil, acetylene black produced through complete combustion and thermal decomposition of acetylene, thermal black produced through complete combustion of natural gas, and channel black produced through incomplete combustion of natural gas. In the present invention, any of the aforementioned carbon blacks can be used.

In the second aspect of the present invention, particularly preferably, oil furnace black or acetylene black is used, for the reasons described below. An important factor in the determination of the ability of carbon black as a conductive material is chain structure (aggregation structure) of primary particles. Typically, carbon black assumes an aggregation in which microspherical primary particles aggregate and form irregular branched chains. When carbon black is in a “high structure state” in which a large number of primary particles are present and chains of the particles are branched to thereby form a complicated structure, the carbon black exerts excellent conductivity imparting effect. Since oil furnace black or acetylene black assumes such a high structure state, it is preferably used.

The fibrous carbon used in the second aspect of the present invention may be basically the same as that used in the first aspect of the present invention but there are some differences and, therefore, it will be described below although overlapping descriptions are included.

Examples of the fibrous carbon which can be used in the second aspect of the present invention include PAN-based carbon fiber, pitch-based carbon fiber, vapor grown carbon fiber, and carbon fiber having a fiber filament diameter of nanometers, which is called “nano-tube.” However, since pitch-based carbon fiber or PAN-based carbon fiber has a long fiber filament length, the carbon fiber is not uniformly mixed with a catalyst easily. Therefore, in consideration of uniform mixing with a catalyst and conductivity, a nano-tube or vapor grown carbon fiber (hereinafter the fiber may be abbreviated as “VGCF”) is preferably used. Particularly, VGCF which has been heat-treated and exhibits enhanced electrical conductivity is preferred, since the VGCF has appropriate elasticity. VGCF is produced through thermal decomposition of a gas, such as hydrocarbon gas, in a vapor phase in the presence of a metallic catalyst.

A variety of processes for producing VGCF are known, including a process in which an organic compound such as benzene or toluene, serving as a raw material, and an organic transition metal compound such as ferrocene or nickelocene, serving as a metallic catalyst, are introduced into a high-temperature reaction furnace together with a carrier gas, to thereby produce VGCF on a substrate (Japanese Patent Application Laid-Open (kokai) No. 60-27700); a process in which VGCF is produced in a dispersed state (Japanese Patent Application Laid-open (kokai) No. 60-54998); and a process in which VGCF is grown on a reaction furnace wall (Japanese Patent No. 2778434). Japanese Patent Publication (kokoku) No. 3-64606 discloses a process in which metal-containing particles carried on a refractory support of, for example, alumina or carbon are brought into contact with a carbon-containing compound at a high temperature, to thereby produce VGCF having an diameter of 70 nm or less.

In the present invention, any of the VGCFs produced through the aforementioned processes can be used.

In the second aspect of the present invention, VGCF having a fiber filament diameter of 500 nm or less and a fiber filament length of 100 μm or less can be used. Preferably, VGCF having a fiber filament diameter of 1-300 nm and a fiber filament length of 80 μm or less is used. VGCF having a fiber filament length of 50 μm or less is more preferred. This VGCF typically has a branched structure. In this case, the term “fiber filament length” refers to the length of a branched filament as measured from one branch point to an end or the length of a filament between two adjacent branch points.

When the fiber filament length of VGCF is more than 100 μm, since the secondary particle size of the conductive powder particles is about 15 μm or less, uniform mixing of the VGCF and the conductive powder particles become difficult. Therefore, thinning of the gas diffusion layer becomes difficult, and remarkable effect is not obtained.

In the second aspect of the present invention, preferably, VGCF is heat-treated in a non-oxidizing atmosphere (e.g., argon, helium, or nitrogen gas) at a temperature of 2,000° C. or higher, preferably 2,500-3,000° C. More advantageously, heat treatment is carried out in the presence of a boron compound. When VGCF is heat-treated in the presence of a boron compound, the heat treatment temperature can be reduced by several hundred degrees as compared with the case in which the boron compound is not used.

No particular limitation is imposed on the boron compound used during heat treatment of VGCF, so long as the boron compound generates boron through heating, and the boron content of VGCF becomes 0.01-10 mass %, preferably 0.1-5 mass % after heat treatment. Examples of the boron compound include boron carbide (B₄C), boron oxide (B₂O₃), boric acid, boric acid salts, boron nitride, and organic boron compounds. The boron compound may assume a solid, liquid, or gaseous form. In the present invention, an inorganic boron compound is preferred, since it is reliably available and enables easy operation. Particularly, boron carbide is preferred.

The amount of a boron compound which is incorporated into VGCF before heat treatment must be larger than the target boron content of VGCF, since boron may be evaporated depending on heat treatment conditions. The amount of a boron compound to be incorporated, which depends on chemical properties and physical properties of the compound, is not particularly limited. When boron carbide is used, it is preferably incorporated into VGCF in an amount of 0.05-10 mass %, more preferably 0.1-5 mass %.

When VGCF is heat-treated at 2,000° C. or higher, not only electrical conductivity but also characteristics such as chemical stability and thermal conductivity are improved. Therefore, when the thus-treated VGCF is used in combination with a catalyst for a fuel cell, power-generating efficiency (the amount of power generated on the basis of unit volume) of the resultant fuel cell is enhanced, and durability of the fuel cell (the ratio of the maximum power of the cell after continuously used for 1,000 hours or more to the initial maximum power of the cell) is also enhanced.

Particularly when VGCF is heat-treated at 2,500° C. or higher, the resultant VGCF of high crystallinity exerts remarkable effect of enhancing such fuel characteristics. Therefore, in the present invention, the degree of graphitization-crystallization of VGCF is enhanced by means of addition of boron. Mixing of a boron compound and VGCF may be carried out by means of any method without using a special apparatus, so long as they are carefully mixed so as to form a uniform mixture.

VGCF may be heat-treated by use of any furnace; for example, an Acheson furnace, a high-frequency furnace, or a furnace employing a graphite heater, so long as VGCF can be treated at a desired temperature.

In the case of an Acheson furnace, a non-oxidizing atmosphere during heating is obtained by burying a substance to be heated into carbon powder. In the case of another furnace, a non-oxidizing atmosphere is obtained by, if desired, substituting an atmosphere by an inert gas such as helium or argon.

No particular limitation is imposed on the heat treatment time, and the heat treatment time may be appropriately determined such that the temperature of the entirety of a substance to be heated reaches a predetermined temperature.

No particular limitation is imposed on the hydrophobic resin, so long as the resin does not prevent gas diffusion, and enables efficient discharge of excess water produced through reaction between oxygen and protons in the catalyst layer of an oxygen electrode (cathode). The surface tension of the hydrophobic resin is preferably lower than that of water (about 72 dyn/cm). Examples of the hydrophobic resin which can be used include a fluorine-based resin, polypropylene, and polyethylene. Of these, a fluorine-based resin is preferred. Examples of the fluorine-based resin include polytetrafluoroethylene (PTFE), polyvinylidene fluoride (PVDF), and tetrafluoroethylene-hexafluoropropylene copolymers (FEP).

Carbon paper, carbon cloth, carbon sheet, etc. may be used as a conductive porous substrate (gas diffusion sheet). Alternatively, carbon sheet disclosed in Japanese Patent Application Laid-Open (kokal) No. 2000-169253 may be used.

A composition containing the conductive powder particles, the hydrophobic resin, and the fibrous carbon preferably assumes the form of a paste (slurry) prepared by mixing a solvent (an organic solvent, water, or a mixture thereof) with at least the conductive powder particles, the hydrophobic resin, and the fibrous carbon. A gas diffusion layer is formed by applying the paste onto the conductive porous substrate; specifically, through application by use of a brush, application through spraying, or screen printing. Alternatively, a gas diffusion layer is formed by immersing the conductive porous into the paste.

A single cell having, for example, a structure shown in FIG. 1 can be produced by sandwiching an electrolyte membrane (ion-exchange membrane) by membrane-electrode assemblies including the gas diffusion layer and the catalyst layer of the second aspect of the present invention, and furthermore, a fuel cell can be produced. The ion-exchange membrane may be a known ion-exchange membrane; for example, a cation-exchange resin membrane. Typically, a perfluorocarbon sulfonic acid membrane is used. Specific examples of the ion-exchange membrane include “Nafion™” produced by Du Pont, “Flemion™” produced by Asahi Glass Co., Ltd., and “Aciplex™” produced by Asahi Chemical Industry Co., Ltd.

In the second aspect of the present invention, as described above, spaces suitable for gas diffusion can be formed through entanglement of filaments of the fibrous carbon by means of the action of the hydrophobic resin, which also serves as a binder. Alternatively, spaces suitable for gas diffusion can be formed through mixing of spherical carbon powder particles serving as the conductive powder particles, the fibrous carbon, and the hydrophobic resin.

The spaces are not completely lost by means of, for example, hot pressing, and the spaces can be maintained, since a cross-linking structure is formed by carbon fiber filaments or through entanglement of carbon fiber filaments with carbon powder particles. Therefore, gas passages can be provided sufficiently after formation of a fuel cell.

Spaces formed by carbon fiber filaments include spaces having a large size. In contrast, in spaces formed by carbon fiber filaments and carbon powder particles, the ratio of spaces having a large size is reduced, since the size of the carbon powder particle is generally smaller than the length of the carbon fiber filament. As a result, distribution of spaces (pores) becomes narrow and sharp, and spaces effective for gas diffusion are considered to increase further. A gas diffusion layer—in which, when the cross section of the layer is observed by use of a scanning electron microscope (SEM), the cross section area of spaces having a size of 0.1-50 μm accounts for 40% or more, preferably 50% or more, of the cross section area of all the spaces—is particularly effective for enhancing gas diffusibility in a high current density region.

As shown in FIG. 6, the internal resistance of a fuel cell is roughly divided into a diffusion resistance component of an electrolyte membrane 11 which is affected by an electrolyte solution and an electrolyte; and a resistance component of an electrode including the contact resistance between a catalyst layer 10 comprising catalyst-bearing carbon particles 12, a gas diffusion layer 9, a conductive porous substrate (gas diffusion sheet) 8, conductive powder particles 14, and fibrous carbon 13, as well as the resistance of the conductive substrate 8, the conductive powder particles 14, and the fibrous carbon 13. In the fuel cell, the contact resistance between the particles is reduced due to the effect of a cross-linking structure formed by the carbon powder particles and the fibrous carbon. In addition, since the fibrous carbon 13 projects from the surface of the gas diffusion layer 9, and the projection portion enters the catalyst layer, the gas diffusion layer is smoothly brought into contact with the catalyst layer, resulting in reduction of contact resistance.

### EXAMPLES

The present invention will next be described in more detail by way of Examples, which should not be construed as limiting the invention thereto.

### Example 1

Acetylene black bearing 50 mass % platinum and graphitized VGCF product (product of Showa Denko K.K., product name: VGCF™) were mixed together, to thereby prepare a catalyst composition for a cell. The graphitized VGCF product was incorporated in an amount of 5 mass % into the primary components of the catalyst composition. The graphitized VGCF product produced by Showa Denko K.K. had a fiber filament diameter of 100 nm, a bulk density of 0.08 g/cm³, and a fiber filament length of less than 100 μm as measured through SEM observation, and more that 90% of the fibers had a branched structure.

To the thus-prepared catalyst composition for a cell were added a 5 mass % ion-exchange resin solution (product of Aldrich, product name: Nafion™) (1 g), and glycerin (5 g), and the resultant mixture was mixed sufficiently by use of a ball mill, to thereby prepare a solution mixture. The solution mixture was applied onto a Teflon sheet, and then dried, to thereby form an electrode material including a conductive substrate and a catalyst layer provided thereon.

Subsequently, a fuel cell was produced by use of the thus-formed electrode material. Specifically, the electrode material having thereof the catalyst layer which was peeled off from the Teflon sheet was bonded to an ion-exchange membrane (product of Du Pont, Nafion 112 (registered trade mark)) through hot pressing, to thereby form a membrane-electrode assembly. The resultant membrane-electrode assembly serving as a gas diffusion electrode was used as an air electrode (cathode). An electrode formed by use of platinum-bearing carbon through the aforementioned mixing, application, and pressing was used as a fuel electrode (anode). Separator plates (length 250 mm×width 250 mm×thickness 8 mm) having grooves were used. A single cell shown in FIG. 1 was produced from the air electrode, the fuel electrode, and the separator plates.

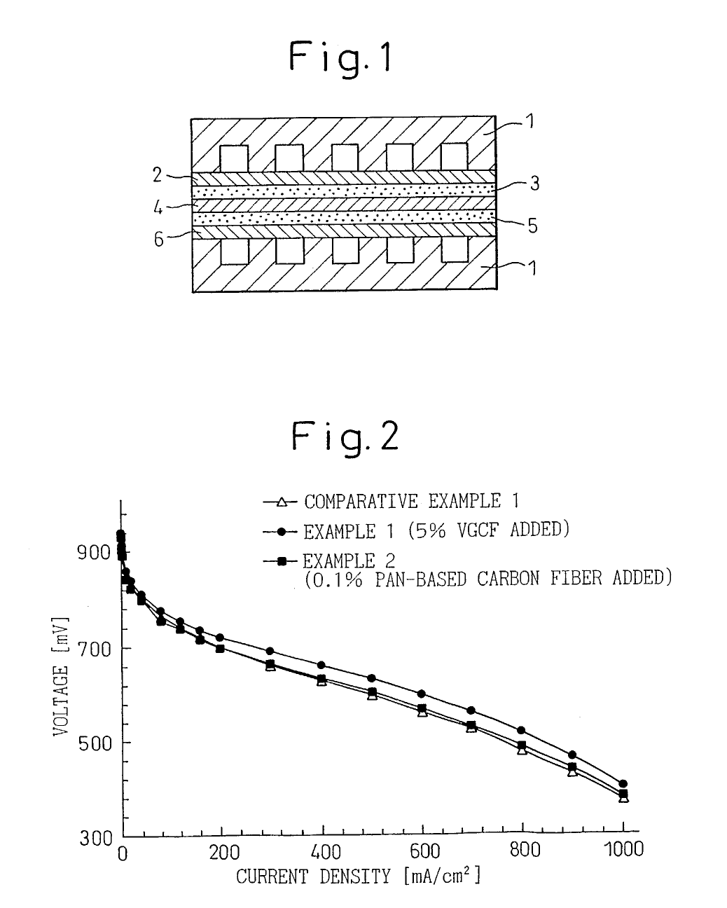

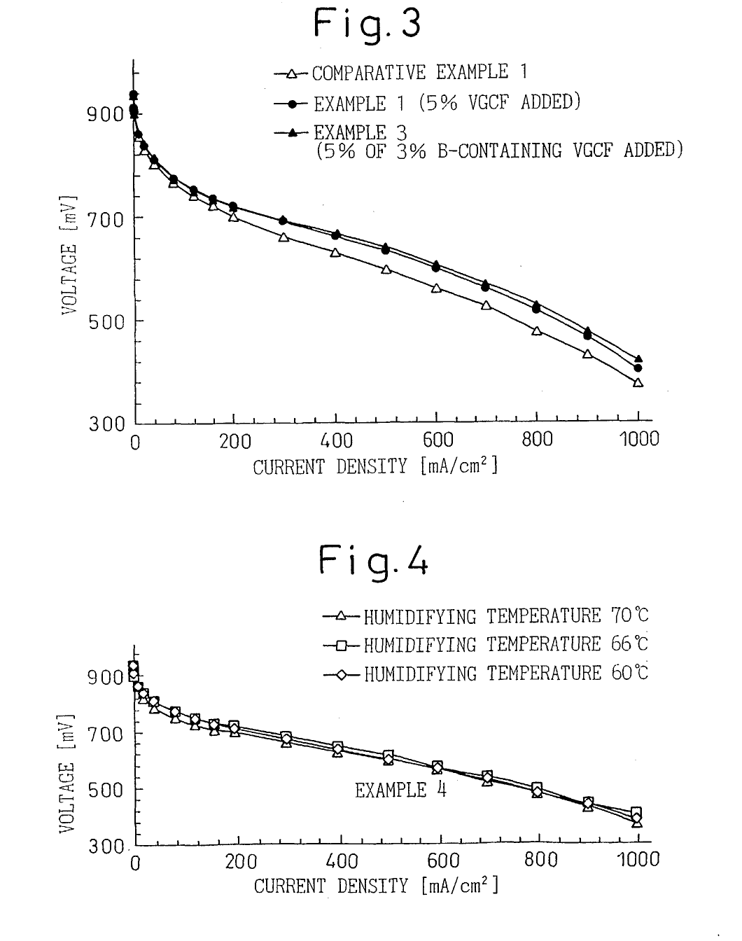

Hydrogen serving as a fuel gas and an oxidizing gas (air) were caused to pass through the thus-produced single cell, and the single cell was operated at a pressure of 0.1 MPa, to thereby evaluate cell characteristics. In order to evaluate cell characteristics, the relation between current density and voltage was investigated under the following conditions: temperature 80° C., hydrogen humidification temperature of the fuel electrode 80° C., and air humidification temperature of the air electrode 70° C. The results are shown in FIGS. 2 and 3.

### Example 2

The procedure of Example 1 was repeated, but the graphitized VGCF product was changed to 0.1 mass % of a PAN-based carbon fiber (fiber diameter of 5 μm and a fiber length of 100 μm), to thereby form a catalyst composition for fuel cell, and produce an electrode and a single cell. Cell characteristics of the thus-produced single cell were evaluated in a manner similar to that of Example 1. The results are shown in FIG. 2.

From FIG. 2, it was confirmed that Example 1, in which 5 mass % of VGCF was added, had an about 10%-improved voltage than Comparative Example 1, in which VGCF was not added. The inner resistivity (mΩ·cm²) was measured at various electric current densities and it was found that the inner resistivity decreased by about 20 mΩ·cm². It was also confirmed that the voltage was improved in Example 2 in which a PAN-based carbon fiber was added.

### Example 3

The procedure of Example 1 was repeated, but 5 mass % of graphitized VGCF product in which 3 mass % boron was contained was used, to thereby form a catalyst composition for fuel cell, and produce an electrode and a single cell. Cell characteristics of the thus-produced single cell were evaluated in a manner similar to that of Example 1. The Results are shown in FIG. 3.

It was shown that when 3 mass % boron-containing VGCF was used, the voltage was improved in comparison with Example 1 in which VGCF was added. It was also shown that the inner resistivity decreased by about 5 mΩ·cm².

### Comparative Example 1

The procedure of Example 1 was repeated, except that VGCF was not incorporated, to thereby form a catalyst composition for a cell, and produce an electrode and a single cell. Cell characteristics of the thus-produced single cell were evaluated in a manner similar to that of Example 1. The results are shown in FIGS. 2 and 3.

### Example 4

A single cell was produced in a manner similar to that of Example 1, and cell characteristics of the single cell were evaluated in a manner similar to that of Example 1. The relation between current density and voltage was investigated at the humidification temperatures of the air electrode (cathode) of 60° C., 66° C., and 70° C. The results are shown in FIG. 4.

### Comparative Example 2

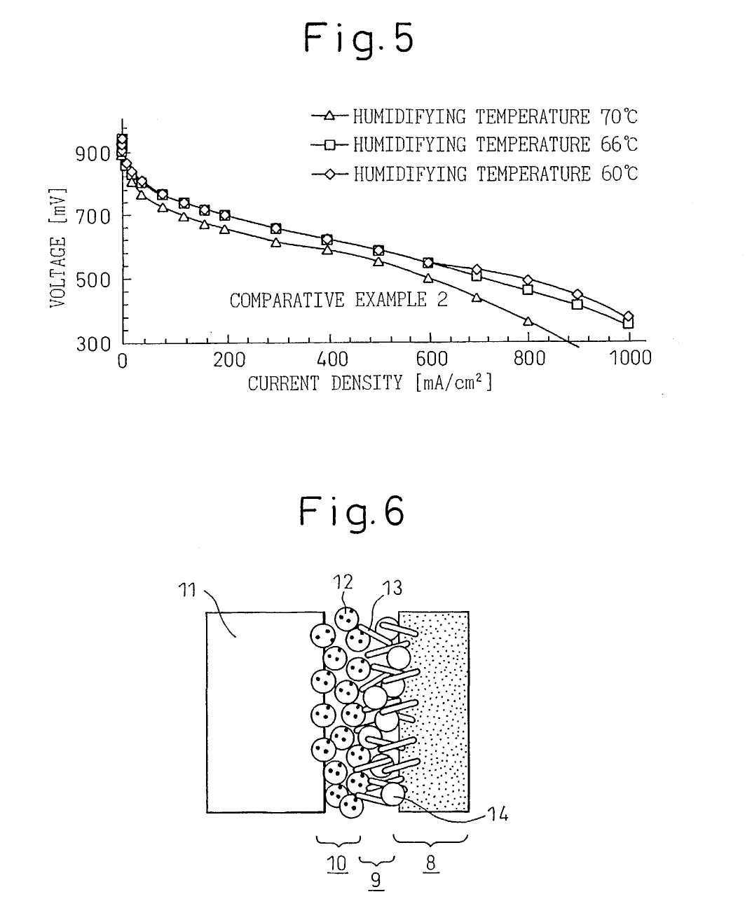

A single cell was produced in a manner similar to that of Comparative Example 1, and cell characteristics of the single cell were evaluated in a manner similar to that of Example 1. The relation between current density and voltage was investigated at the humidification temperatures of the air electrode (cathode) of 60° C., 66° C., and 70° C. The results are shown in FIG. 5.

As is apparent from FIG. 2, the voltage of the cell of Example 1 in which VGCF is incorporated in an amount of 5 mass % is increased by about 10% as compared with that of the cell of Comparative Example 1 in which VGCF is not incorporated. The internal resistance (mΩ·cm²) as measured at each current density (mA/cm²) is reduced by about 20 mΩ·cm².

Comparison between Example 4 and Comparative Example 2 shown in FIGS. 4 and 5 reveals that the cell of Example 4 in which VGCF is incorporated in an amount of 5 mass % barely undergoes change in voltage even when the humidification temperature of the air electrode is varied; i.e., humidification control is carried out easily, and that the voltage of the cell of Comparative Example 2 in which VGCF is not incorporated decreases drastically when the humidification temperature of the air electrode is changed by 10 degrees from 60° C. to 70° C.; i.e., the cell undergoes drastic change in voltage.

### Example 5

Carbon particles (product of Showa Cabot K.K., product name: Vulcan XC-72, average particle size: 30 nm), a fluorine-based resin (PTFE), and a graphitized VGCF product (product of Showa Denko K.K., product name: VGCF™) were mixed together, to thereby prepare a slurry for a gas diffusion layer. For preparation of the slurry, Vulcan XC-72 and the graphitized VGCF product were mixed in a mass ratio of 2:8. The fluorine-based resin was incorporated into the slurry in an amount of 40 mass %. The graphitized VGCF product had a fiber filament diameter of 100 nm, a bulk density of 0.08 g/cm³, and a fiber filament length of less than 100 μm as measured through SEM observation, and more than 90% of the fibers had a branched structure.

The thus-prepared slurry was sprayed uniformly onto a carbon cloth, and then dried, to thereby form a gas diffusion sheet including a gas diffusion layer.

Subsequently, a slurry prepared by mixing Ketjen Black bearing 50 mass % platinum serving as a catalyst with an ion-exchange resin was applied to an ion-exchange membrane (product of Du Pont, Nafion™ 112 (registered trade mark)) through hot pressing, to thereby form a membrane-electrode assembly. The above-formed gas diffusion sheet was provided on an air electrode (cathode) of the membrane-electrode assembly. A porous gas diffusion sheet not containing a carbon layer was provided on a fuel electrode (anode) of the membrane-electrode assembly. A single cell shown in FIG. 1 was produced from the thus-formed electrodes and separator plates (length 250 mm×width 250 mm×thickness 2 mm) having grooves.

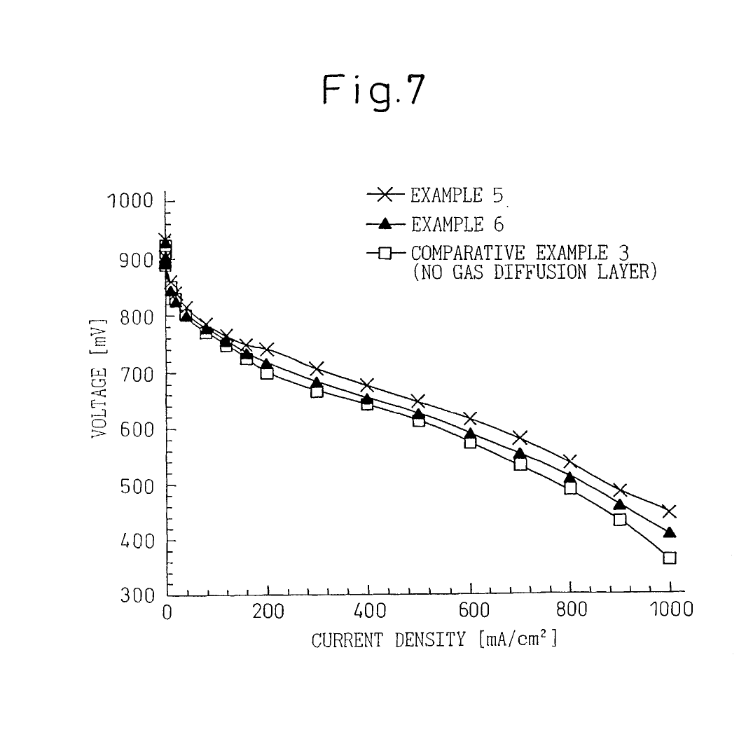

Hydrogen serving as a fuel gas and an oxidizing gas (air) were caused to pass through the thus-produced single cell, and the single cell was operated at a pressure of 0.1 MPa, so as to evaluate cell characteristics. In order to evaluate cell characteristics, the relation between current density and voltage was investigated under the following conditions: temperature 80° C., hydrogen humidification temperature of the fuel electrode 80° C., and air humidification temperature of the air electrode 70° C. The results are shown in FIG. 7.

### Example 6

A fluorine-based resin (PTFE) and a graphitized VGCF product (product of Showa Denko K.K., product name: VGCF™) were mixed together, to thereby prepare a slurry for a gas diffusion layer. The fluorine-based resin was incorporated into the slurry in an amount of 40 mass %. A gas diffusion layer was formed from the slurry in a manner similar to that of Example 5. Cell characteristics of the resultant single cell were evaluated. The results are shown in FIG. 7.

### Comparative Example 3

The procedure of Example 5 was repeated, except that a carbon cloth not including a gas diffusion layer is used instead of a gas diffusion sheet including a gas diffusion layer, to thereby prepare a catalyst composition for a cell and produce an electrode and a single cell. Cell characteristics of the thus-produced single cell were evaluated in a manner similar to that of Example 5. The results are shown in FIG. 7.

As is apparent from FIG. 7, the voltage of the cell of Example 5 in which conductive carbon particles are incorporated and a gas diffusion layer containing VGCF is provided is increased by about 10% as compared with that of the cell of Comparative Example 3 in which VGCF is not incorporated. The internal resistance (mΩ·cm²) as measured at each current density (mA/cm²) is reduced by about 20 mΩ·cm². The results showed that cell characteristics of the cell of Example 6 in which a gas diffusion layer formed from VGCF alone is provided are more enhanced as compared with those of the cell of Comparative Example 3.

### Example 7

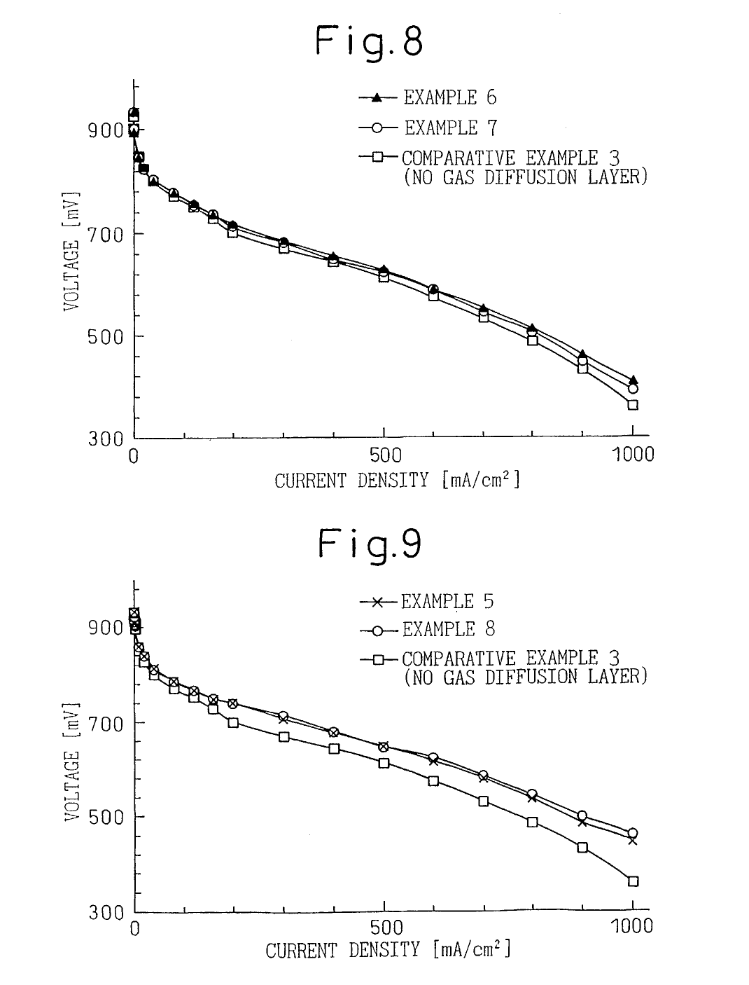

A slurry for a gas diffusion layer was prepared by mixing a fluorine-containing resin PTFE and a PAN-based carbon fiber (diameter of 5 μm and length of 100 μm). The fluorine-containing resin was added in an amount of 40 mass %. The slurry was used in a manner similar to Example 5, to form a gas diffusion layer and characteristics of a fuel cell produced were evaluated. The results are shown in FIG. 8.

It was shown that a PAN-based carbon fiber made the power generation property improved when used in a gas diffusion layer, as VGCF, but the improvement was lower than when VGCF was used.

### Example 8

The procedure of Example 5 was repeated but VGCF added with 3 mass % of boron was used in the gas diffusion layer, and the power generation property was evaluated. The results are shown in FIG. 9.

As a result of use of a boron-added VGCF with an improved electric conductivity, the inner electric resistivity decreased by about 5 mΩ·cm² and the power generation property was improved in comparison with when VGCF was used in the gas diffusion layer.

Industrial Applicability

As described above in detail, according to the first aspect of the present invention, there can be obtained a catalyst composition for a cell, which prevents “wetting” of a catalyst layer, causes no change in electrical resistance or reduction of electrical resistance, provides gas passages for enhancing gas permeability, and enables enhancement of power-generating characteristics and simple humidification control; an electrode material; and a fuel cell. The fuel cell including a catalyst layer formed from the catalyst composition containing catalyst-bearing conductive powder particles and fibrous carbon enables enhancement of power-generating efficiency and simple humidification control. Particularly, a catalyst composition for a cell containing VGCF serving as fibrous carbon is preferred. The primary components of the catalyst composition preferably contain VGCF in an amount of 0.1-30 mass %. When VGCF contains boron in an amount of 0.01-10 mass % and is graphitized at a temperature of 2,300° C. or higher, conductivity can further be enhanced.

As described above in detail, the second aspect of the present invention provides a gas diffusion layer containing VGCF which causes no change in electrical resistance or reduction of electrical resistance, and which provides gas passages for enhancing gas permeability. The present invention also provides a fuel cell of enhanced power-generating characteristics. Particularly, a gas diffusion layer containing VGCF serving as fibrous carbon is preferred. VGCF is preferably incorporated into the gas diffusion layer in an amount of 1-95 mass %. When VGCF contains boron in an amount of 0.01-10 mass % and is graphitized at a temperature of 2,000° C. or higher, conductivity can further be enhanced.

1. A fuel cell comprising an electrolyte sandwiched by electrodes having a catalyst layer and a gas diffusion layer, or an assembly used therefor, characterized in that (i) the catalyst layer comprises a catalyst-bearing conductive powder particles and a fibrous carbon, and/or (ii) the gas diffusion layer comprises a layer containing a water repellant resin and a fibrous carbon at least part of the surface of the gas diffusion layer in contact with the catalyst layer.

2. A catalyst composition for a cell comprising catalyst-bearing conductive powder particles and fibrous carbon.

3. The catalyst composition for a cell as claimed in claim 2, wherein the catalyst accelerates oxidation-reduction reaction in a fuel cell.

4. The catalyst composition for a cell as claimed in claim 2 or 3, wherein the catalyst is platinum or a platinum alloy.

5. The catalyst composition for a cell as claimed in any one of claims 2 through 4, wherein the conductive powder particles are conductive carbon black or conductive carbonaceous powder particles.

6. The catalyst composition for a cell as claimed in any one of claims 2 through 5, wherein the conductive powder particles are at least one species selected from the group consisting of furnace black, acetylene black, thermal black, channel black, and Ketjen Black.

7. The catalyst composition for a cell as claimed in any one of claims 2 through 6, wherein the fibrous carbon is at least one species selected from the group consisting of PAN-based carbon fiber, pitch-based carbon fiber, and a carbon nano-tube.

8. The catalyst composition for a cell as claimed in any one of claims 2 through 6, wherein the fibrous carbon is vapor grown carbon fiber.

9. The catalyst composition for a cell as claimed in claim 7 or 8, wherein the entirety of the catalyst-bearing conductive powder particles and the fibrous carbon contains the fibrous carbon in an amount of 0.1-30mass %.

10. The catalyst composition for a cell as claimed in claim 8 or 9, wherein the vapor grown carbon fiber has been heat-treated at a temperature of at least 2,300° C.

11. The catalyst composition for a cell as claimed in any one of claims 8 through 10, wherein the vapor grown carbon fiber contains boron in an amount of 0.01-10mass %.

12. The catalyst composition for a cell as claimed in any one of claims 7 through 11, wherein the fibrous carbon has a fiber filament diameter of 10-300 nm.

13. The catalyst composition for a cell as claimed in any one of claims 7 through 12, wherein the fibrous carbon has a fiber filament length of 100 μm or less.

14. An electrode material comprising a conductive substrate and a catalyst layer formed thereon, the catalyst layer containing a catalyst composition for a cell as recited in any one of claims 2 through 13.

15. The electrode material as claimed in claim 14, wherein the conductive substrate is a porous conductive substrate.

16. A polymer electrolyte fuel cell comprising a polymer electrolyte membrane and a pair of electrodes which sandwich the electrolyte membrane, each electrode including a catalyst layer, characterized in that the catalyst layer includes a conductive substrate and a catalyst layer containing catalyst-bearing conductive powder particles and fibrous carbon.

17. A membrane-electrode assembly for a fuel cell comprising an electrolyte membrane and an electrode including a catalyst layer and a gas diffusion layer, the electrode being provided on each surface of the electrolyte membrane, wherein at least a portion of the surface of the gas diffusion layer which is in contact with the catalyst layer includes a layer containing a hydrophobic resin and fibrous carbon.

18. The membrane-electrode assembly for a fuel cell as claimed in claim 17, wherein at least a portion of the surface of the gas diffusion layer which is in contact with the catalyst layer further includes conductive powder particles.

19. The membrane-electrode assembly for a fuel cell as claimed in claim 17 or 18, wherein at least a portion of the surface of the gas diffusion layer which is in contact with the catalyst layer further includes spaces.

20. The membrane-electrode assembly for a fuel cell as claimed in claim 19, wherein, in a cross section of the gas diffusion layer, the cross section area of spaces having a size of 0.1-50 μm accounts for at least 40% of the total cross section area of all the spaces.

21. The membrane-electrode assembly for a fuel cell as claimed in any one of claims 18 through 20, wherein the conductive powder particles are conductive carbon black or conductive carbon powder particles.

22. The membrane-electrode assembly for a fuel cell as claimed in any one of claims 17 through 21, wherein the fibrous carbon of the layer comprising the hydrophobic resin and the fibrous carbon is vapor grown carbon fiber, and the layer contains the vapor grown carbon fiber in an amount of 1-95 mass %.

23. The membrane-electrode assembly for a fuel cell as claimed in claim 22, wherein the vapor grown carbon fiber has been formed through heat treatment at a temperature of at least 2,000° C.

24. The membrane-electrode assembly for a fuel cell as claimed in claim 22 or 23, wherein the vapor grown carbon fiber contains boron in an amount of 0.01-10mass %.

25. The membrane-electrode assembly for a fuel cell as claimed in any one of claims 22 through 24, wherein the vapor grown carbon fiber has a fiber filament diameter of 500 nm or less.

26. The membrane-electrode assembly for a fuel cell as claimed in any one of claims 22 through 25, wherein the vapor grown carbon fiber has a fiber filament length of 100 μm or less.

27. The membrane-electrode assembly for a fuel cell as claimed in any one of claims 17 through 26, wherein the hydrophobic resin is a fluorine-based resin.

28. A process for producing a layer assembly for a fuel cell, comprising a step for forming a gas diffusion layer by applying a conductive porous substrate onto or immersing the conductive porous substrate in a composition comprising conductive powder particles, a hydrophobic resin, and fibrous carbon; a step for forming an electrode by forming a catalyst layer comprising catalyst-bearing carbon particles on the surface of the gas diffusion layer, the composition being applied onto the surface of the gas diffusion layer or the gas diffusion layer being immersed in the composition; and a step for bonding the catalyst layer of the electrode to each surface of an electrolyte membrane.

29. A fuel cell comprising a membrane-electrode assembly as recited in any one of claims 17 through 27 and separators which sandwich the membrane-electrode assembly.

30. A fuel battery comprising at least two fuel cells as recited in claim 29, which are layered together.
